(19) United States
(12) Patent Application Publication
(10) Pub. No.: US 2018/0025400 A1
(43) Pub. Date: Jan. 25, 2018

(54) ELECTRONIC COMMERCE SEARCHING ASSISTANT

(71) Applicant: MOBIFALCON, INC., DALLAS, TX (US)

(72) Inventor: Ebennezer Eshun, Frisco, TX (US)

(73) Assignee: MOBIFALCON, INC., DALLAS, TX (US)

(21) Appl. No.: 15/547,305

(22) PCT Filed: Feb. 24, 2016
(86) PCT No.: PCT/US16/19371

§ 371 Date: Jul. 28, 2017

Related U.S. Application Data
(60) Provisional application No. 62/120,853, filed on Feb. 25, 2015.

(51) Int. Cl. G06Q 30/06; G06F 17/30

(52) U.S. Cl. CPC G06Q 30/0605; G06F 17/30887; G06Q 10/1097

(57) ABSTRACT

The present invention relates generally to the field of E-commerce, and more particularly to distributing commercial data associated with a plurality of commercial entities over a wireless communication channel to a remote vendee computer. A commercial data viewer application is provided to a vendee for installation on the remote vendee computer. Commercial data is received at a transmission server that comprises a microprocessor and a memory that stores the vendee's preference for an information format, a commerce object, a vendor, a transaction type. The microprocessor filters the received commercial data; generates a commercial notification comprising a name, a price, a transaction type, and a URL, which specifies the location of the server; formats the commercial notification; and transmits the formatted commercial notification the remote vendee computer. The commercial notification is displayed on the remote vendee computer to allow the vendee to finalize a commercial transaction associated with the commercial notification.

### CROSS-REFERENCE TO RELATED APPLICATIONS

This application is a 371 application of PCT/US16/19371 filed Feb. 24, 2016, which claims priority to U.S. Provisional Application No. 62/120,853 filed Feb. 25, 2015, which are each hereby incorporated herein by reference.

### BACKGROUND

The present invention relates generally to electronic commerce and specifically to programs for facilitating the simultaneous purchase of commercial objects from a plurality of electronic commerce entities. Electronic commerce (“Ecommerce”) can generally be ascribed to any type of business or commercial transaction that involves the transfer of information across the Internet. The term generally applies to all four of the major market segments: business to business, business to consumer, consumer to consumer and consumer to business. Ecommerce can generally allow consumers and businesses to electronically exchange goods and/or services with no barriers of time or distance. E-commerce can assist businesses and/or entrepreneurs in establishing a market presence, or to enhance an existing market position, by providing a cost effective distribution chain for their goods and/or services as compared to traditional brick-and-mortar establishments.

### BRIEF DESCRIPTION OF THE DRAWINGS

FIG. 1 depicts an environment, generally 100, in accordance with an embodiment of the present invention.

FIG. 2 depicts a data transmission scheme, generally 200, in accordance with an embodiment of the present invention.

FIG. 3A depicts the operational steps of the task execution program, in accordance with an embodiment of the present invention.

FIG. 3B depicts additional operational steps of the task execution program, in accordance with an embodiment of the present invention.

FIG. 4 depicts a block diagram of the components of a computing device, in accordance with an embodiment of the present invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. Note that the computer-usable or computer-readable medium could even be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

As used herein, real-time information refers to information that is received by a recipient computing device without perceived delay subsequent to its input in a transmitting computing device. The term “goods” as used herein reflects tangible commodities that may be consumed and/or provides utility. The term “services” as used herein represent an act or acts performed for a recipient or purchaser. Applicable services can include, but are not limited to, medical services, health services, vehicular installation services, vehicular repair services, household repair services, utility installation services, utility repair services, personal grooming services, pet grooming services, hardware installation services, expert services, and/or hardware repair services. Services are typically intangible. The terms “goods” and “products” are herein utilized interchangeably. The term preferred refers to a vendee preference. The term “commercial transaction” refers to purchasing, selling, scheduling, and/or delivering goods and services.

Electronic commerce (“E-commerce”) generally refers to the trading of goods and/or services (“commerce objects”) using computer networks, such as the Internet. E-commerce can generally be ascribed to any type of business or commercial transaction that involves the transfer of information across the Internet. The term generally applies to all four of the major market segments: business to business, business to consumer, consumer to consumer and consumer to business. E-commerce can generally allow consumers and businesses to electronically exchange commerce objects with no barriers of time or distance. Typically, vendees generate a shopping list having a plurality of preferred commerce objects. For each commerce object on the list, vendees typically visit a plurality of E-commerce sites individually to ascertain pricing, object availability, and to purchase commerce objects. Alternatively, for local brick-and-mortar vendors proximate to vendees, the vendees typically have to visit each vendor separately to ascertain commerce object availability as well as conduct commercial transactions.

Embodiments of the present invention seek to provide a program that simultaneously searches commercial data associated with a plurality of brick-and-mortar vendors following a preferred criteria. Other embodiments of the present invention seek to provide a program that determines the commercial availability of preferred commerce objects within a predefined geographical region. Additional embodiments of the present invention seek to provide a program that schedules commerce objects deliveries according to a preferred criteria. Yet still other embodiments of the present invention seek to provide a program that schedules service appointments according to a preferred criteria.

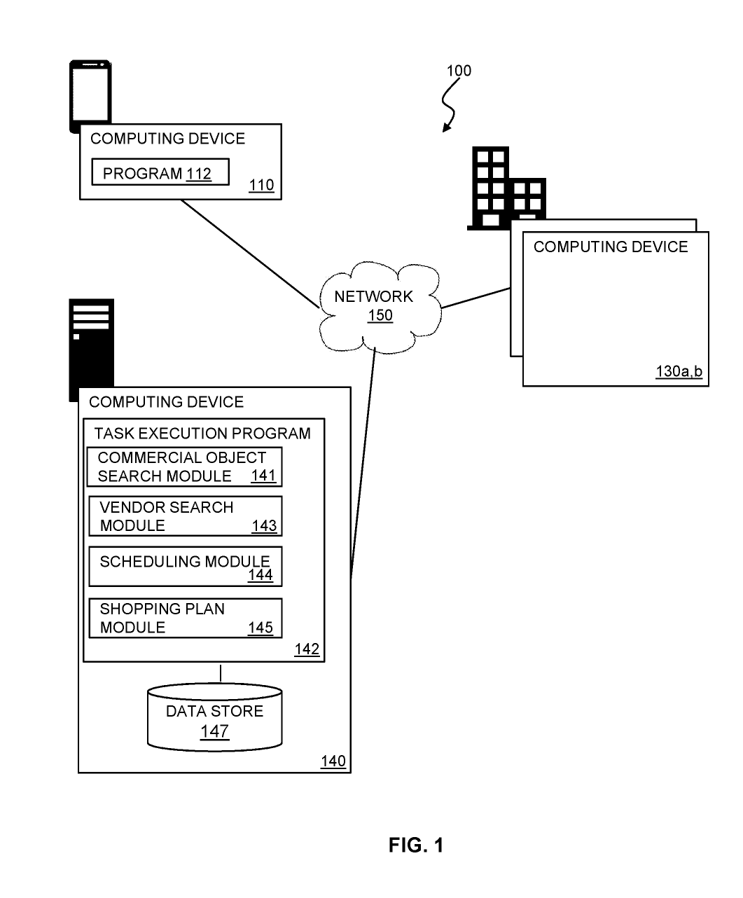

FIG. 1 is a block diagram that depicts an environment, generally 100, in accordance with an embodiment of the present invention. Environment 100 includes computing devices 110, 130a,b, and 140, in communication via network 150. Computing devices 110, 130 a,b, and/or HO can be a desktop computer, a wearable computer, a mobile computing device, a laptop computer, a tablet computer, a computer server, a vehicular-based computer, a home-integrated computer, a thin client, and/or any computing device that can cute code and communicate, in accordance with an embodiment of the present invention. Computing devices 110, 130a,b, and/or 140 can transmit information in real-time. Network 150 can be, for example, a local area network (LAN), a wide area network (WAN) such as the Internet, or a combination of the two, and can include wired, wireless, or fiber optic connections. In general, network 150 can be any combination of connections and protocols that support communications between computing devices 110, 1300, and 140.

Computing device 110 is a computing device that can be used to engage in E-commerce activity, in accordance with an embodiment of the present invention. Computing device 110 can include program 112, which can be a mobile application, the can access commercial data and/or receive formatted commercial data to conduct commercial transactions.

Program 112 can retrieve, present, and traverse information resources (“IR”) available on the Internet, private networks, and/or network 150. Program 112 can receive formatted commercial data from TEP 142. Program 112 can generate and transmit E-commerce search queries (“ESQs”) to TEP 142. ESQs can comprise purchase requests for preferred commercial objects and/or vendor delivery dates, such as commercial objects associated with computing devices 130a,b. ESQs can also comprise shopping lists comprising one or more preferred commercial objects for immediate and/or future purchase. Here, ESQs can comprise preferred purchase dates/times, vendee availability date/times, delivery date/times, quantities, geospatial locations, prices, price ranges, vendorIDs, vendor ratings, and/or price thresholds.

Computing devices 130a,b are computing devices that may be associated with vendors, in accordance with an embodiment of the present invention. Computing devices 130a,b can generate and/or transmit commercial data. Commercial data can comprise data generate by inventory management systems and/or appointment scheduling systems, such as inventory levels, orders, sales data, and/or scheduling information. Commercial data may be associated radio transponder tagged commerce objects. Such tagged commerce objects can provide location-based data points. Computing devices 130a,b may be associated with brick-and-mortar commercial entities (“BAMCEs”).

Commercial data can be generated using RFID transponders, serial numbers, barcodes, lot numbers, and/or revision numbers associated with commercial objects. Commercial data can be used to track commercial objects that are picked, packed, and/or shipped from a warehouse. Computing device 140 is a computing device that can receive, analyze, and/or format commercial data, and transmits at least a portion of that data for display on a vendee's computer device, such as computing device 110, to facilitate commercial transactions, in accordance with an embodiment of the present invention. Computing device 140 can include task execution program 142, which is in communication with data store 147. Data store 147 is an information repository that can comprises commercial data, such as commercial data received from computing devices 130a,b.

Data store 147 can receive real-time commercial data from computing devices 130a,b in response to the input and/or update of the commercial data included therein. Data store 147 may be external to computing device 140 and directly in communication with network 150. Data store 147 can include commercial data formatted by date/time availability, quantities, discounts, special offerings, geolocational information, commercial objectIDs, vendee reviews, commercial object prices, and/or vendorIDs.

Task execution program (“TEP”) 142 is software that analyzes, formats, and/or transmits commercial data, in accordance with an embodiment of the present invention. TEP 142 can analyze commercial data from a plurality of commercial entities. TEP 142 can format commercial data according to vendee specified criteria. TEP 142 can service ESQs received from program 112. TEP 142 can include commercial object search module (“COSM”) 141, vendor search module (“VSM”) 143, scheduling module (“SM”) 144, and/or SPM 145.

COSM 141 can provide purchase information for commercial objects, for example, commercial objectID, cost, vendorID, vendor location, and/or in-store item location. PSSM 141 can generate a list of preferred and/or similar commercial objects having prices at, above, and/or below a preferred value and/or value range. PSSM 141 can determine whether preferred and/or similar commercial objects are available in data store 147. For example, similarity between commercial objects can be determined by the commercial object's type, quantity, volume, brand, vendor, price, and/or service region.

VSM 143 is software that searches data store 147 for preferred and/or similar vendors using a preferred criteria, in accordance with an embodiment of the present invention. VSM 143 can generate the directions for locating vendors that are included in data store 147. VSM 143 can generate a list of vendors that provide preferred and/or similar commercial objects.

For example, the vendor list can comprise commercial data formatted by price, vendor distance from a preferred location, vendor location, and/or preferred brand. Vendor lists can format merchants by price, distance from a predefined location, and/or brand, wherein at least a portion of the merchants may be included data store 147. SM 144 is software that can schedule and confirm commercial object delivery and/or appointments according to preferred criteria. SM 144 can suggest alternative appointment times (i.e. the next available date/time), if there is a scheduling conflict. SM 144 can generate notifications of future appointments at preferred intervals. SM 144 can generate notifications for commercial transaction confirmations and/or conflicts.

SM 144 can arrange and/or confirm delivery of commercial objects via unmanned vehicles. For example, SM 144 can receive delivery confirmations from either of computing devices 130a,b and transmit the received confirmations to program 112 for display on computing device 110. In response to receiving SEQs comprising delivery requests, SM 144 can transmit the received delivery requests to either of computing devices 130a,b for processing and verification. SM 144 can store scheduling information in data store 147. SPM 145 is software that can generate reports that format preferred commercial objects by price, availability, and/or distance, in accordance with an embodiment of the present invention.

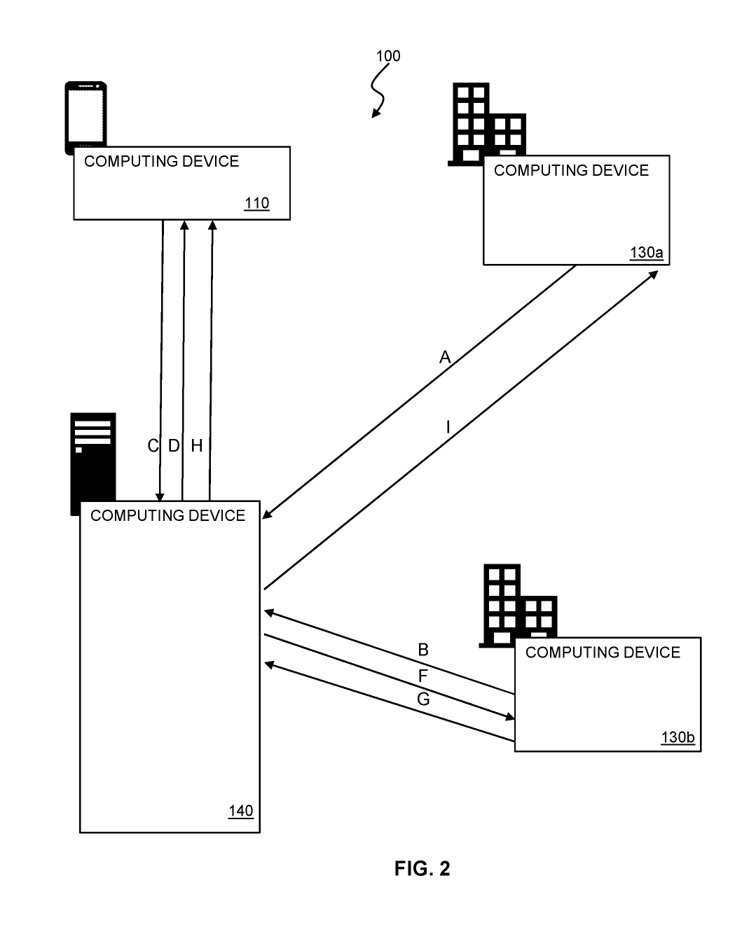

FIG. 2 illustrates an information transmission scheme (“ITS”) that occurs within environment 100, in accordance with an embodiment of the present invention. ITS 100 depicts the information transmissions required for TEP 142 to facilitate the purchase of commercial objects according to a preferred criteria. Computing devices 130a,b are associated with brick-and-mortar establishment (“BAMEs”) that desire to sell their commercial objects via E-commerce methods. In response, the BAMEs transmit the associated commercial data to computing device 140.

In addition, each BAME links their inventory management system and/or scheduling software to computing device 140, which allows any resulting commercial data to be transmitted to computing device 140 in real-time. For example, computing device 130a has commercial products that can be purchased and delivered to a preferred location and/or pre-purchased for in-store pickup. This particular brick and mortar establishment updates their inventory list to reflect the receipt of a new shipment of commercial objects A, B, and C.

Computing device 130b is associated with a service provider, for example, a dental service provider, that is located in region A and operates during normal business hours (9:00 AM to 5:00 PM) on Mondays, Wednesdays, and Thursdays and is expanding their serviceable regions to include regions A and B. In response to receiving inventory updates for products A, B, and C, computing device 130a transmits, via transmission A, the commercial data updates to computing device 140 for storage in data store 147. In response to receiving the update for service B, computing device 130b transmits, via transmission B, the commercial data update for product B to computing device 140 for storage in data store 147.

For example, vendors A and B can be associated with computing devices 130a,b, respectively. The vendee associated computing device 110 generates an ESQ for the purchase of product A (“goods request”) and service B (“service request”) from the primary website included in data store 147. Computing device 110 transmits the ESQ to computing 140 via transmission C. COSM 141 analyzes the data in data store 147 and determines that product A and service B are available for purchase. SPM 145 generates a delivery request for product A using the vendee's preferred information included in data store 147 and transmits the delivery request via transmission I.

In response to receiving an associated scheduling confirmation, computing device 140 generates a delivery scheduling confirmation for product A and transmits the confirmation to program 112 for display on computing device 110. Computing device 140 also determines that service B is available on the preferred date/time. SM 144, via computing device 140, transmits a scheduling request for service B to computing device 130b via transmission F. Program 132b confirms the appointment and in response transmits the confirmation to computing device 140 via transmission G. Upon receipt, computing device 142 formats the confirmation according to a preferred criteria and transmits the formatted data to program 112 for display on computing device 110 via transmission H.

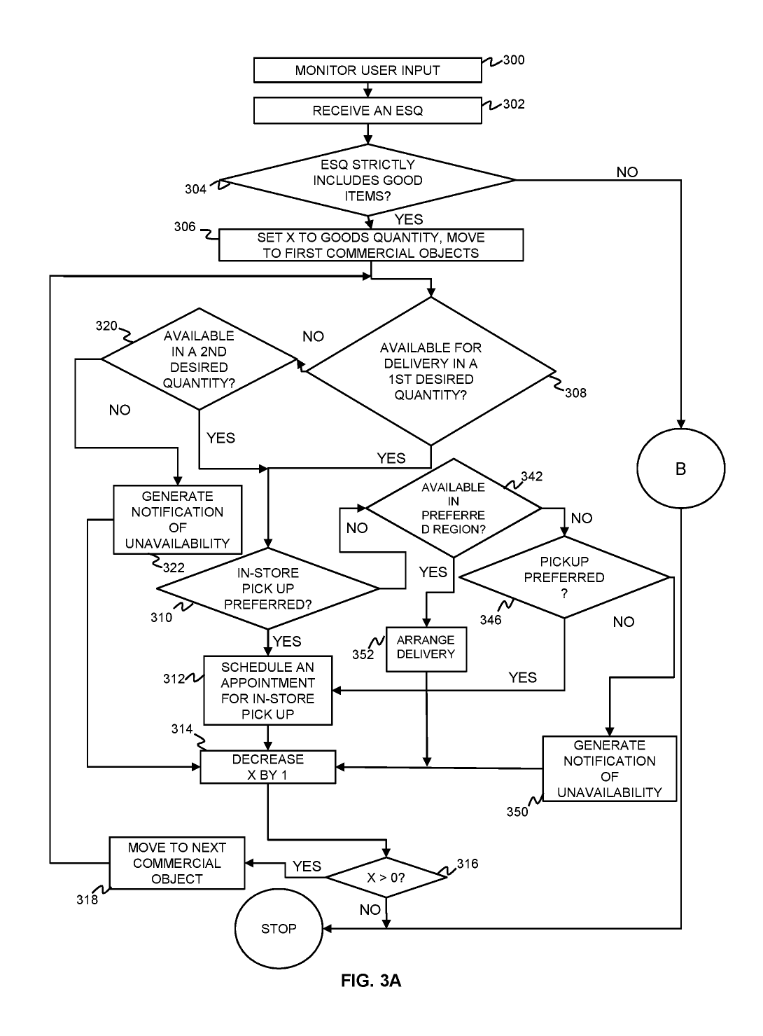

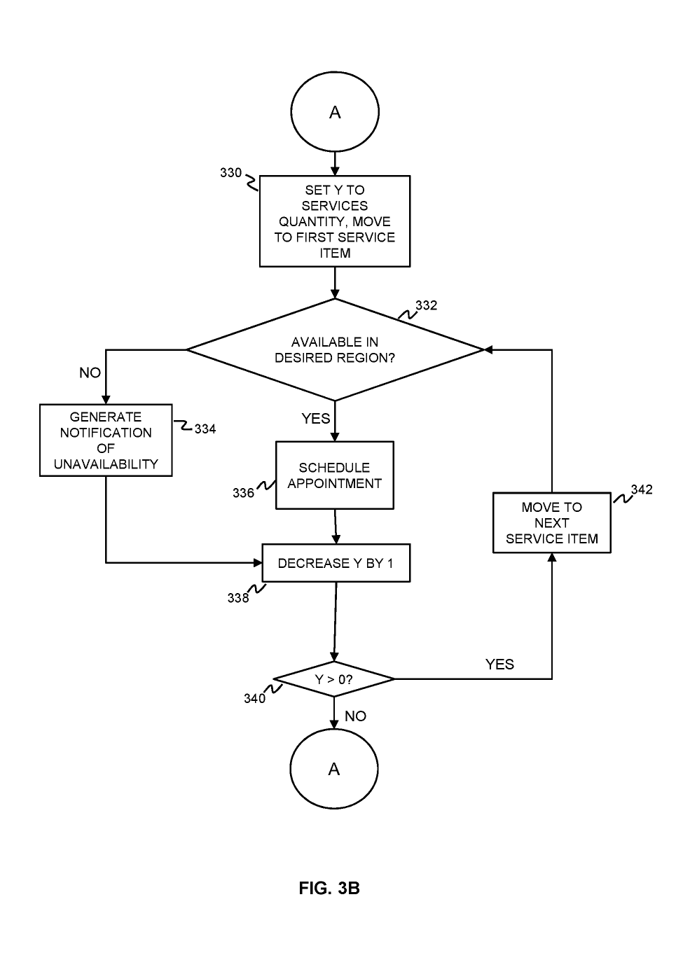

FIG. 3 depicts the operational steps of TEP 142, in accordance with an embodiment of the present invention. TEP 142 monitors vendee input (step 300). TEP 142 receives an ESQ (step 302). If TEP 142 determines that the ESQ includes goods (“yes” branch, decisional 304), TEP 142 sets X to the goods quantity and moves to the first goods item (step 306). If TEP 142 determines that the goods item is not available in a first preferred quantity (“no” branch decisional 308), TEP 142 determines whether the goods item is available in a second preferred quantity (decisional 320).

If TEP 142 determines that the goods item is not available in the second preferred quantity (“no” branch decisional 320), TEP 142 generates a notification of unavailability (step 322) and proceeds to step 314. If TEP 142 determines that goods item are available in a second preferred quantity (“yes” branch decisional 320), TEP 142 proceeds to step 310. If TEP 142 determines that goods item is available in a first preferred quantity (“yes” branch decisional 308), TEP 142 determines whether an in-store pickup of the goods item is preferred (decisional 310).

If TEP 142 determines that there is a desire for an in-store pickup of the goods item is preferred (“yes” branch decisional 310), TEP 142 schedule an in-store pick up (step 312). Task manager program 142 decreases X by 1 (step 314). If TEP 142 determines that X is not greater than 0 (“no” branch decisional 316), TEP 142 stops. If TEP 142 determines that X is greater than 0 (“no” branch decisional 316), TEP 142 moves to the next goods item (step 318) and proceeds to step 308 (discussed above).

If TEP 142 determines that there is no desire for an in-store pick-up of the goods item (“no” branch decisional 310), TEP 142 determines whether the goods item is available for delivery in the preferred region (decisional 308). If TEP 142 determines that the goods item is available for delivery in the preferred region (“yes” branch decisional 342), TEP 142 arranges for delivery (step 352) and proceeds to step 314. If TEP 142 determines that the goods item is not available for delivery in the preferred region (“no” branch decisional 342), TEP 142 determines whether an in-store pick up is preferred (decisional 346).

If TEP 142 determines that an in-store pick up is preferred (“yes” branch decisional 346), TEP 142 proceeds to step 312 (discussed above). If TEP 142 determines that an in-store pick up is not preferred (“no” branch decisional 346), TEP 142 generates a notification of unavailability (step 350) and proceeds to step 314 (discussed above).

FIG. 3B depicts additional operational steps of TEP 142, in accordance with an embodiment of the present invention. If TEP 142 determines that the ESQ does not strictly comprise goods item (“no” branch decisional 304), TEP 142 proceeds to step B. Specifically, if TEP 142 determines that the ESQ does not strictly comprise goods items (“no” branch decisional 304), TEP 142 sets Y to the service item quantity and moves to the first service item (step 330). If TEP 142 determines that the service item is not available in the preferred region (“no” branch decisional 332), TEP 142 generates a notification of unavailability (step 334) and proceeds to step 338 (discussed below).

If TEP 142 determines that the service item is available in the preferred region (“yes” branch decisional 332), TEP 142 schedules an appointment for the service item (step 336). TEP 142 decreases Y by one (step 338) and determines whether Y is greater than 0 (step 340). If TEP 142 determines that Y is greater than zero (“yes” branch decisional 340), TEP 142 moves to the next service item (step 342) and proceeds to decisional 332 (discussed above). If TEP 142 determines that Y is not greater than zero (“no” branch decisional 340), TEP 142 returns to step A and stops.

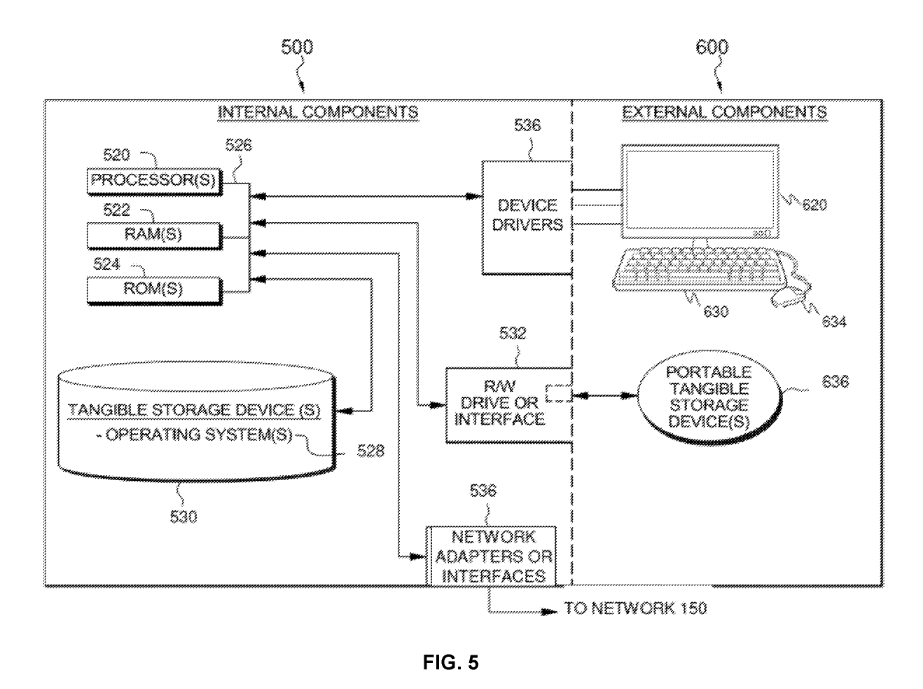

FIG. 4 depicts a block diagram of components of computing device 140, in accordance with an embodiment of the present invention. Data processing system 500, 600 is representative of any electronic device capable of executing machine-readable program instructions. Data processing system 500, 600 may be representative of a smart phone, a computer system, PDA, or other electronic devices. Examples of computing systems, environments, and/or configurations that may represented by data processing system 500, 600 include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

Computing device 140 includes respective sets of internal components 500 and external components 600 as illustrated in FIG. 4. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. One or more of TEP 142 and data store 147 are stored on one or more of the respective computer-readable tangible storage devices 530 for execution by one or more of processors 520 via one or more of the respective RAMs 522 (which typically include cache memory). In the embodiment illustrated in FIG. 4, each of the computer-readable tangible storage devices 530 is a magnetic disk storage device of an internal hard drive.

Alternatively, each of the computer-readable tangible storage devices 530 is a semiconductor storage device, such as ROM 524, EPROM, flash memory or any other computer-readable tangible storage device that can store a computer program and digital information. Internal components 500 also include a R/W drive or interface 532 to read from and write to one or more portable computer-readable tangible storage devices 636, such as a CD-ROM, DVD, memory stick, magnetic tape, magnetic disk, optical disk or semiconductor storage device. TEP 142 and/or data store 147 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as a TCP/IP adapter cards, wireless Wi-Fi interface cards, or 3G or 4G wireless interface cards or other wired or wireless communication links. TEP 142 and/or data store 147 can be downloaded to computing device 140, respectively, from an external computer via a network (for example, the Internet, a local area network or other, wide area network) and respective network adapters or interfaces 536. From the network adapters or interfaces 536, TEP 142 and/or data store 147 in computing devices 140 are loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard 630, and a computer mouse 634. External components 600 can also include touch screens, virtual keyboards, touch pads, pointing devices, and other human interface devices. Internal components 500 also include device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

As various modifications could be made in the constructions and methods herein described and illustrated without departing from the scope of the invention, it is intended that all matter contained in the foregoing description or shown in the accompanying drawings shall be interpreted as illustrative rather than limiting. Thus the breadth and scope of the present invention should not be limited by any of the above-described exemplary embodiments, but should be defined only in accordance with the following claims appended hereto and their equivalents.

What is claimed is:

1. A method for distributing commercial data associated with a plurality of commercial entities over a wireless communication channel to a remote vendee computer, the method comprising:
providing a commercial data viewer application to a vendee for installation on the remote vendee computer;
receiving commercial data at a transmission server sent from a commercial entity data source over the internet, the transmission server comprising a microprocessor and a memory that stores the remote vendee's preference for an information format, a commerce object, a vendor, a transaction type, wherein the microprocessor:
filters the received commercial data by comparing the received commercial data to the preferred commerce object;
generates a commercial notification from the filtered commercial data that contains a commerce object name, a commerce object price, a transaction type and a universal resource locator (“URL”), which specifies the location of the transmission server;
formats the commercial notification into data blocks according to the information format;
transmits the formatted commercial notification over the wireless communication channel to the remote vendee computer; and
wherein the commercial notification activates the commercial data viewer application to cause the commercial notification to display on the remote vendee computer to enable connection via the URL to the commercial entity data source over the Internet to allow the vendee to finalize a commercial transaction associated with the commercial notification.

2. The method of claim 1, wherein the plurality of commercial entities comprises a brick-and-mortar commercial entity.

3. The method of claim 1, wherein the commercial transaction comprises purchasing the commercial object.

4. The method of claim 1, wherein the transaction type comprises a commercial object delivery event, a commercial object scheduling event, and/or a commercial object in-store pick up event.

5. The method of claim 1, wherein the commercial notification further contains a listing reflecting whether the commerce object price is equal to, above, and/or below a preferred value.

6. The method of claim 1, wherein the commercial data is received at the transmission server in real-time in response to an associated change at the commercial entity data source.

7. The method of claim 1, wherein the commercial data source receives commercial data points from radio transponder tagged commerce objects.

8. A computer program product for distributing commercial data associated with a plurality of commercial entities over a wireless communication channel to a remote vendee computer, the computer program product comprising a computer readable storage medium having program code embodied therewith, the program code executable by a processor to:
receive an commercial data at a transmission server sent from a commercial entity data source over the internet, the transmission server comprising a microprocessor and a memory that stores a remote vendee's preference for an information format, a commerce object, a vendor, a transaction type;
wherein the remote vendee computer comprises a commercial viewer application;
wherein the microprocessor executes program code to:
filter the received commercial data by comparing the received commercial data to the preferred commerce object;
generate a commercial notification from the filtered commercial data that contains a commerce object name, a commerce object price, a transaction type and a universal resource locator (“URL”), which specifies the location of the transmission server;
format the commercial notification into data blocks according to the information format;
transmit the formatted commercial notification over the wireless communication channel to the remote vendee computer; and
wherein the commercial notification comprises computer code to activate the commercial viewer application to cause the commercial notification to display on the remote vendee computer to enable connection via the URL to the commercial entity data source over the Internet to allow the vendee to finalize a commercial transaction associated with the commercial notification.

9. The computer program product of claim 8, wherein the plurality of commercial entities comprises a brick-and-mortar commercial entity.

10. The computer program product of claim 8, wherein the commercial transaction comprises purchasing the commercial object.

11. The computer program product of claim 8, wherein the transaction type comprises a commercial object delivery event, a commercial object scheduling event, and/or a commercial object in-store pick up event.

12. The computer program product of claim 8, wherein the commercial notification further contains program code for a listing reflecting whether the commerce object price is equal to, above, and/or below a preferred value.

13. The computer program product of claim 8, wherein the commercial data is received at the transmission server in real-time in response to an associated change at in the commercial entity data source.

14. The computer program product of claim 8, wherein the commercial data source receives commercial data points from radio transponder tagged commerce objects.

15. A computer system for distributing commercial data associated with a plurality of commercial entities over a wireless communication channel to a remote vendee computer, the computer system comprising:
one or more computer processors;
one or more computer-readable storage media;
program instructions stored on the computer-readable storage media for execution by at least one of the one or more processors, the program instructions comprising:
program instructions to
receive commercial data at a transmission server sent from a commercial entity data source over the internet, the transmission server comprising a microprocessor and a memory that stores a remote vendee's preference for an information format, a commerce object, a vendor, a transaction type;
wherein the remote vendee computer comprises a commercial viewer application;
wherein the microprocessor executes program instructions to:
filter the received commercial data by comparing the received commercial data to the preferred commerce object;
generate a commercial notification from the filtered commercial data that contains a commerce object name, a commerce object price, a transaction type and a universal resource locator (“URL”), which specifies the location of the transmission server;
format the commercial notification into data blocks according to the information format;
transmit the formatted commercial notification over the wireless communication channel to the remote vendee computer; and
wherein the commercial notification comprises program instructions to activate the commercial viewer application to cause the commercial notification to display on the remote vendee computer to enable connection via the URL to the commercial entity data source over the Internet to allow the vendee to finalize a commercial transaction associated with the commercial notification.

16. The computer system of claim 15, wherein the plurality of commercial entities comprises a brick-and-mortar commercial entity.

17. The computer system of claim 15, wherein the commercial transaction comprises purchasing the commercial object.

18. The method of claim 15, wherein the transaction type comprises a commercial object delivery event, a commercial object scheduling event, and/or a commercial object in-store pick up event.

19. The computer program product of claim 15, wherein the commercial notification further contains program instructions for a listing reflecting whether the commerce object price is equal to, above, and/or below a preferred value.

20. The computer system of claim 19, further comprising:
wherein the commercial data is received at the transmission server in real-time in response to an associated change at in the commercial entity data source; and/or
wherein the commercial data source receives commercial data points from radio transponder tagged commerce objects.
